(19) United States
(12) Patent Application Publication
(10) Pub. No.: US 2025/0331672 A1
(43) Pub. Date: Oct. 30, 2025

(54) FLOW BALANCING POUR-OVER COFFEE DRIPPER

(71) Applicant: Bartosz Bojanowski, Redwood City, CA (US)

(72) Inventor: Bartosz Bojanowski, Redwood City, CA (US)

(21) Appl. No.: 18/856,186

(22) PCT Filed: Sep. 6, 2024
(86) PCT No.: PCT/US2024/045488

§ 371 Date: Oct. 11, 2024

Related U.S. Application Data
(60) Provisional application No. 63/538,092, filed on Sep. 13, 2023.

(51) Int. Cl. A47J 31/02; A47J 31/06; A47J 31/44

(52) U.S. Cl. CPC A47J 31/02; A47J 31/0626; A47J 31/4403

(57) ABSTRACT

Apparatus for splitting liquid flow including a funnel configured to receive a liquid therein, a first wall having a drain opening and a splitter positioned adjacent the drain opening configured to separate the liquid into i) a first liquid portion for flow into a first liquid receptacle and ii) a second liquid portion for flow into a second liquid receptacle.

### BACKGROUND

This application claims priority from provisional application 63/538,092, filed Sep. 13, 2023, the entire contents of which are incorporated herein by reference.

### FIELD OF THE INVENTION

This invention relates to a coffee brewing apparatus, and, more particularly, to a pour-over coffee dripper which can simultaneously brew into more than one cup.

### DESCRIPTION OF THE RELATED ART

Coffee beverages are very popular around the world and several brewing techniques have been developed aimed at optimizing the flavor of these beverages. One technique is the pour-over dripper method which typically brews a single serving of coffee. In this process, a dripper vessel in a shape resembling a cup on a saucer with a through hole in the center is placed on the rim of a cup/mug, then a filter is placed inside the dripper cup/cone. Coffee grounds are poured inside the filter and hot water is poured over the grounds to brew and extract flavors of the coffee (e.g., the filtrate or extraction), which then passes through the porous filter and flows down to the drain hole(s) in the bottom of the dripper vessel and into the cup beneath.

Most pour-over coffee drippers, such as those disclosed in U.S. Pat. Nos. 2,234,397, 10,709,283 and U.S. Publication 2022/0378242, describe a filter holding device for brewing one serving of coffee into a single cup or vessel at a time. These filter holders or “drippers” are placed directly on the rim of a beverage container or cup for brewing. To make more than one cup of coffee, this setup requires another brewing/pour-over sequence and double the time. Additionally, pouring over the already-extracted coffee will yield poorly tasting brew, so another serving of coffee grounds is required to match the strength and flavor of the initial brewed cup.

Alternatively, other brewing techniques such as disclosed in U.S. Pat. No. 5,826,493 and U.S. Publication 2019/0191914, describe brewing into a larger vessel/carafe in order to brew a larger quantity of coffee for more than one cup or employing a valve that restricts drainage of the brew. This setup requires additional beverage containers in addition to the coffee cup(s) and limits the freshness of brewed coffee since the larger brewed volume will have time to cool between brewing and pouring into additional cups. A drainage restricting valve on the dripper apparatus also prolongs the brewing or extraction process in the dripper, thereby affecting flavor and/or strength of the coffee between cup pours/fills. This is undesirable because it produces inconsistent brew strength/flavor between cups.

Both of the above options require more steps after the initial pour-over brewing/extraction when making more than one cup of coffee. These methods are inefficient for pour-over brewing because they require extra time/steps and involve dirtying multiple dishes/vessels when compared to pour-over brewing directly into the cup(s) from which coffee will be consumed.

U.S. Pat. No. 10,307,009 describes a pour-over coffee dripper that can fill two cups simultaneously via dual drain holes at the bottom of the filter vessel/dripper. However, there are major limitations with such design due to uneven drainage of brew through the drain holes resulting in noticeably varied amounts of coffee in the cups. Uneven drainage can be either due to flow variations inside the filter basket, uneven flow through the filter, or uneven filter placement/seating in the dripper basket such that flow to one drain hole is obstructed by the filter which is common with drippers that have multiple drain holes.

More importantly, however, coffee filters such as Melitta-style conical filters commonly used for pour-over brewing (i.e., #2 or #4 filters), are made of filter paper that has been folded and joined/sealed on two edges (bottom and one side) to create a conical “basket” shape. The seam on these filters has to be folded over before placing into any coffee maker or dripper for it to be properly seated in the filter basket. This fold restricts flow on one side of the filter, which ensures flow through the filter and inside such dripper is always uneven, preventing uniform drainage and equal filling of multiple cups.

Another drawback of this type of dripper is that any mismatch between cup heights causes the dripper to tilt towards the shorter cup being filled. Even if the cups are from the same set, it is rare for two of the cups or mugs to be of equal height, since tolerances in manufacturing methods of such glassware or ceramics typically exceed several millimeters. This unequal height causes increased flow towards one side of the dripper and increases accumulation of the brew/filtrate around the lower drain hole. This results in increased drainage to one cup and ensures uneven filling between the two cups. Hence, equal/balanced filling of two cups would rarely, if ever, be attainable with such drippers.

In view of the foregoing, it would be beneficial to provide an apparatus that could readily ensure equal/balanced filling of multiple cups at the same time. Such apparatus could advantageously be used for coffee as well as other fluids, including other hot fluids.

### SUMMARY

The present invention overcomes the problems and deficiencies of the prior art. The present invention provides a pour over coffee dripper that enables equal/balanced filling of coffee simultaneously into multiple cups. More specifically, the present invention provides an apparatus in the form of a pour-over coffee dripper that has a single drain hole (also referred to herein as a dripper opening or nozzle) at the bottom of the dripper funnel and adjacent the hole is a divider that splits flow evenly among two or more drain channels below the filter cone to permit filling of two cups/mugs at the same time. The funnel contains features that assist in the funneling of the fluid toward the drain hole and into contact with the divider. The underside of the dripper base has features that allow it to sit securely on top of a single cup or on top of two adjacent cups/mugs of various sizes while brewing pour-over coffee, thereby preventing sliding of the dripper off the cups. The underside could also be configured to sit securely on three or more cups of coffee if made for use to simultaneously pour into three or more cups.

The dripper in some embodiments has features on its underside that provide spacers so the channels and divider are out of contact with a counter top or other surface on which it is placed.

The dripper funnels of the present invention have features, described in detail below, which balance or more evenly distribute the flow of brew from the filter and into the cups even if the cups are unequal height (i.e., if the dripper is tilted more towards one cup vs the other due to the differing cup height).

In alternate embodiments, the flow splitting features of the drippers of the present invention can be configured as an attachment or an insert (e.g., an accessory or adapter) to current or conventional drippers to modify such drippers to permit brewing into multiple cups simultaneously.

The drippers of the present invention can be used for splitting flow of fluids other than coffee.

In accordance with one aspect of the present invention, an apparatus for splitting drinkable liquid flow is provided comprising a) a funnel having a proximal portion and a distal portion, the funnel configured to receive a liquid therein; b) a first wall having a drain hole, the funnel opening to the first wall to provide flow onto the first wall; and c) a splitter positioned adjacent the drain hole, the splitter configured to separate the liquid into i) a first liquid portion for flow into a first liquid receptacle and ii) a second liquid portion for flow into a second liquid receptacle.

In some embodiments, the funnel is configured to receive an insert for coffee, e.g., a coffee filter or an insert for brewing or steeping a beverage.

In some embodiments, first and second ribs extend from the first wall adjacent the drain hole, the first and second ribs spaced apart to create first and second gaps to direct liquid flow through the drain hole and onto the splitter.

In some embodiments, the splitter comprises first and second walls extending at an angle with respect to the drainage hole. The splitter is preferably centered with respect to the drain hole.

In some embodiments, a plurality of ribs extend inwardly from an inner wall of the funnel. In some embodiments, the plurality of ribs extend onto the first wall and terminate at a distal region extending upwardly from the first wall. In some embodiments, in the distal region the plurality of ribs extend at an acute angle to a longitudinal axis of the first wall.

In preferred embodiments, the first wall is sloped downwardly toward the drain hole.

The apparatus can include a plurality of legs or feet extending radially with respect to the first wall, the plurality of legs configured to engage the liquid receptacles. In some embodiments, the plurality of legs include a plurality of ridges on a bottom surface to engage a rim of the first liquid receptacle to prevent sliding on the rim. In some embodiments, the plurality of legs have projections on a bottom surface for spacing the apparatus from a surface on which the apparatus is placed so the spouts are out of contact with the surface. The legs can form a substantially x-shape to match a shape of the receptacle(s) over which it is mounted.

The splitter can be configured to divide the liquid into the first liquid receptacle and the second liquid receptacle of either a same size or a different size.

In some embodiments, first and second channels are positioned below the funnel and drain hole and extend radially outwardly with respect to the first wall, each of the first and second channels having an exit for the liquid from the apparatus to the first and second liquid receptacles, the exit of the first and second channels being downstream of the splitter.

In accordance with another aspect of the present invention, an apparatus for splitting drinkable liquid flow is provided comprising an elongated wall having a drain opening formed therein, a splitter positioned adjacent the drain opening, the splitter configured to separate the liquid into i) a first liquid portion for flow into a first liquid receptacle and ii) a second liquid portion for flow into a second liquid receptacle, and a plurality of legs extending radially with respect to the elongated wall configured to engage the first and second liquid receptacles.

In some embodiments, the apparatus includes a receptacle to receive liquid from a dripper. In some embodiments, the receptacle has a rim, and a base of the dripper is seated on the rim such that liquid flows from the dripper onto the splitter. In other embodiments, the receptacle has an opening configured to receive a portion of a dripper, and a portion of the dripper is positioned within the receptacle, wherein liquid flows from the dripper onto the splitter.

### BRIEF DESCRIPTION OF THE DRAWINGS

So that those having ordinary skill in the art to which the subject invention appertains will more readily understand how to make and use the apparatus (device) disclosed herein, preferred embodiments thereof will be described in detail hereinbelow with reference to the drawings, wherein:

FIG. 1 is a side perspective view of one embodiment of the dripper of the present invention;

FIG. 2 is a top view of the dripper of FIG. 1 showing the inside of the dripper filter cone;

FIG. 3A is a cross-sectional side view of the filter cone bottom and drain channels of the dripper of FIG. 1 showing the divider extending below the drainage hole and the channels;

FIGS. 3B and 3C are close up views of the image of FIG. 3A showing the divider, drainage hole and bottom ribs;

FIG. 3D is a top perspective view showing the divider of FIG. 3A extending across the opening in the drainage hole;

FIG. 4A is a side perspective view showing the dripper of FIG. 1 seated on two adjacent cups for simultaneous filling of both cups;

FIG. 4B is a side view showing the dripper of FIG. 1 seated on two adjacent cups of uneven height for simultaneous filling of both cups;

FIG. 5 is a perspective view showing the dripper of FIG. 1 seated on a single cup;

FIG. 6 is a bottom perspective view showing the underside of the dripper base and feet of the dripper of FIG. 1;

FIG. 7 is a bottom view of the dripper of FIG. 1 and showing schematically (in outline) two side by side cups underlying the dripper;

FIG. 8 is a side perspective view of another embodiment of the dripper of the present invention;

FIG. 9 is a bottom perspective view of the dripper of FIG. 8 showing the orientation of the drain channels;

FIG. 10 is a top perspective view of an alternate embodiment of the floor ribs of the dripper of the present invention;

FIG. 11 is a top perspective view of an alternate embodiment of the floor ribs of the dripper of the present invention;

FIG. 12A is a close up view of an alternate embodiment of the floor ribs of the dripper of the present invention;

FIG. 12B is a close up view of an alternate embodiment of the floor ribs of the dripper of the present invention;

FIG. 13 is a side view of an alternate embodiment of the dripper of the present invention having a handle;

FIG. 14 is a bottom view of an alternate embodiment of the channel arrangement of the dripper of the present invention;

FIG. 15A is a side perspective view of an alternate embodiment of the dripper of the present invention having bottom ridges for cup engagement;

FIG. 15B is a side view of the dripper of FIG. 15A;

FIG. 15C is a bottom perspective view of the legs of the dripper of FIG. 15A;

FIG. 15D is a perspective view of the legs (feet) of FIG. 15C;

FIG. 15E is a bottom view of the dripper of FIG. 15A;

FIG. 16 is a side perspective view showing the dripper of FIG. 15A seated on two adjacent cups for simultaneous filling of both cups;

FIG. 17 is a side view showing the dripper of FIG. 15A seated on two adjacent cups of uneven height for simultaneous filling of both cups;

FIG. 18 is a top perspective view of an embodiment of the dripper adapter of the present invention;

FIG. 19 is a side perspective view of the dripper adapter of FIG. 18;

FIG. 20 is a bottom perspective view of the dripper adapter of FIG. 18;

FIG. 21 is a cross-sectional view of the adapter of FIG. 18; and

FIG. 22 is a side view of the dripper adapter of FIG. 18.

### DETAILED DESCRIPTION

The present invention provides a pour over coffee dripper that enables equal/balanced filling of coffee simultaneously into multiple cups. The dripper of the present invention is in the shape of a cone forming a funnel that has a single drain hole (opening or nozzle) at the bottom of the dripper funnel which is then divided evenly to split the flow. The dripper receives a coffee filter in which coffee grounds are placed and when hot water is poured, it mixes with the coffee grounds and flows through the porous filter into the dripper and out into the cups placed below. The dripper of the present invention further has features on its underside that provide secure seating on top of a single cup or on top of two adjacent cups/mugs. It is also contemplated that the underside could be configured to sit securely on three or more cups if made for use to simultaneously pour three or more cups.

The dripper funnel of the present invention advantageously can balance or more evenly distribute the flow of fluid, e.g., brew, from the filter into the two cups even if the cups are of unequal height (i.e., if the dripper is tilted more towards one cup vs the other).

In some embodiments, the flow splitting features of the dripper of the present invention can be an attachment or an insert (e.g., an accessory or adapter) to current drippers to modify such drippers to permit brewing into multiple cups simultaneously.

As used herein, the term “proximal” refers to the section, portion, component. etc., closer to the user and the term “distal” refers to the section, portion, component further from the user such that the liquid flows from a proximal region to exit a distal region of the dripper. As used herein the term “downwardly” refers to the downward direction of liquid flow such that the liquid flows downwardly toward and through the drain hole.

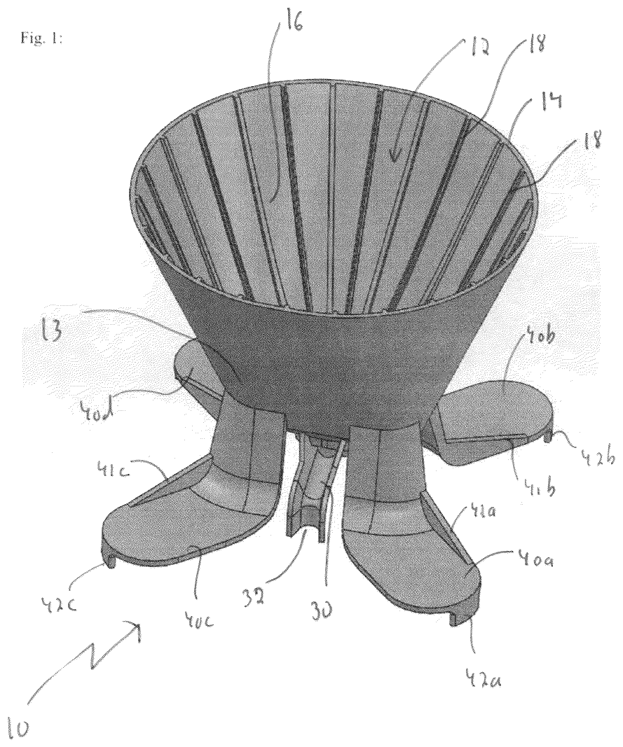

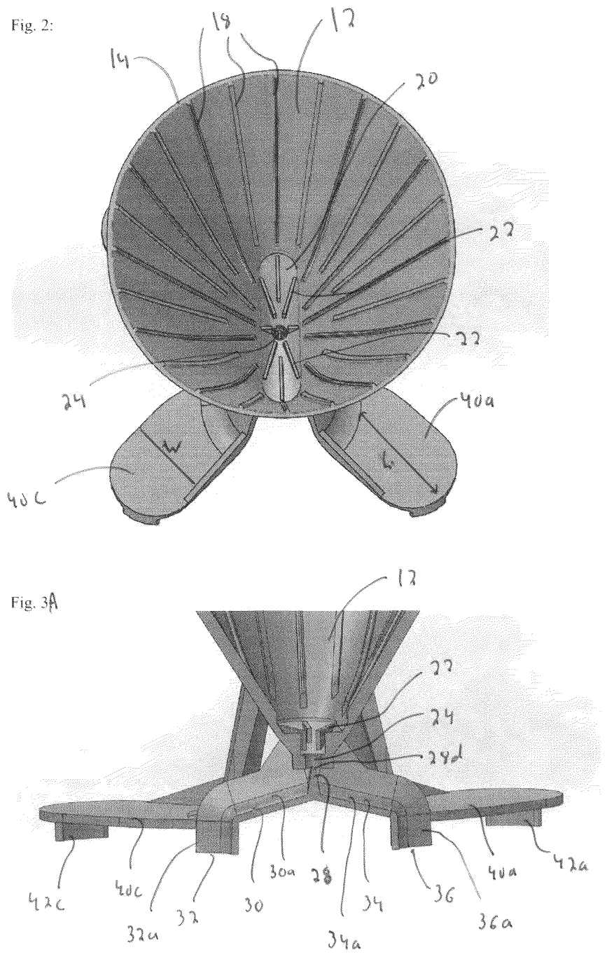

Referring now to the drawings and particular embodiments of the present invention wherein like reference numerals identify similar structural features of the apparatus/devices disclosed herein, FIGS. 1-7 illustrate an embodiment of the dripper of the present invention. The dripper is designated generally by reference numeral 10, and with initial reference to FIGS. 1 and 2, is conical shaped forming a basket or funnel 12 that has an open receiving area 16 configured to receive a typical cone or conical type coffee filter (not shown), the open receiving area 16 sloping/converging inwardly to bottom surface 20 (also referred to herein as a first or lower wall) so the funnel opens to the surface 20).

The filter (not shown) sits within the dripper funnel 12 which has facets or ribs 18 extending longitudinally from the top rim 14, or slightly spaced from the top rim 14, of the funnel 18 toward the drainage (drain) hole 24 (FIG. 2). The ribs (ridges) 18 preferably continue to the bottom surface 20, separating the filter from funnel surfaces to provide unobstructed gaps/channels for fluid flow towards the drain hole 24. The ribs ensure the filter stays separated from the funnel walls and lifted off the bottom surface to ensure flow. The ribs 18 (only a few of which are labeled for clarity) guide the liquid towards the drain hole 24 or reservoir which is at the at the oval bottom surface 20 of the dripper funnel 12. Two or more of the ribs can be of uniform height or can taper (or step down) in height toward the drainage hole 24. Also, two or more of the ribs can be of the same length or can be of different lengths. Further, two or more of the ribs can be identical or can be of different shapes, sizes, thicknesses, heights, lengths, patterns and cross-sections, such as semi-circular or triangular cross-sections. The ribs can taper, e.g., reduce in height, toward or away from rim 14.

These features or ribs 18 on the inside surface of the funnel 20 create capillary spaces between the inserted filter and inner funnel walls to enable liquid (filtrate) drainage or flow through the filter and down the funnel wall. This ensures uniform flow between the funnel wall and filter towards the drain hole 24 from all sides. These features or ribs 18 also prevent pooling/accumulation of liquid on one side of the filter and ensure uniform and more consistent extraction of coffee within the filter.

In some embodiments, at least some of the side wall ribs 18 continue onto the floor/bottom surface 20.

The drainage hole 24 coincides with the lowest point or depression of the funnel 12 to enable drainage, and the bottom surface 20 (also referred to herein as the funnel floor) is sloped towards the drain hole 24, with the slope being sufficient such that liquid drains even when the dripper 10 is not horizontal (i.e., tilted at 5 degrees or at other angles). This slope angles downwardly from opposing ends of the bottom surface toward the center hole. This slope can be from all sides of the bottom surface.

The sloped bottom surface 20 also has facets or floor ribs (ridges) 22 (only a few of which are labeled for clarity in FIG. 2) that direct flow of the liquid toward the center drainage hole 24 and support the bottom of the filter during brewing while keeping it from obstructing flow to drainage hole 24 as it is maintained spaced above the drainage hole 24. That is, the bottom of the filter when placed within the funnel 12 of the dripper 10 will rest against a top surface of the floor ribs 22, leaving adequate distance so the filter does not contact and thereby block the drainage hole 24.

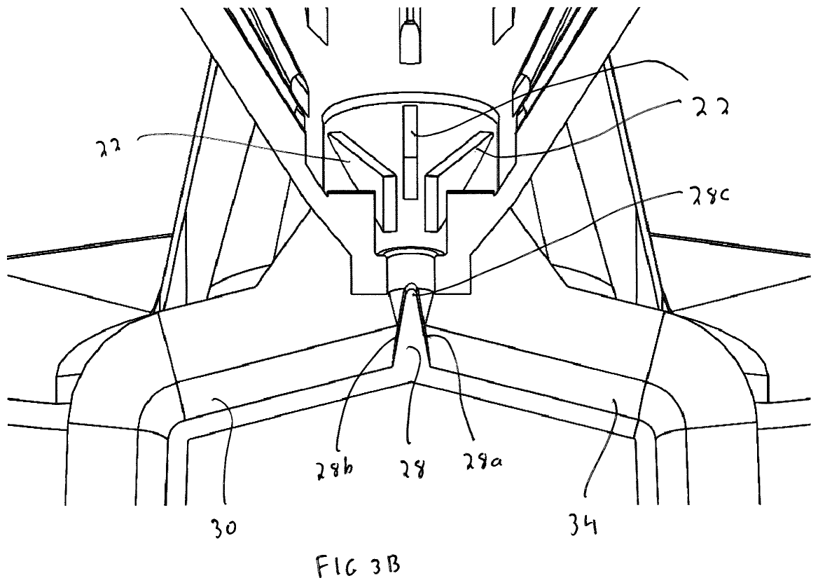

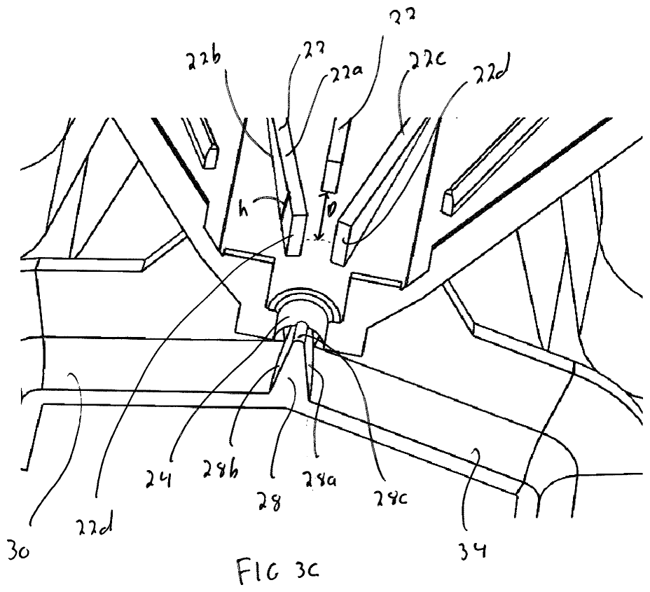

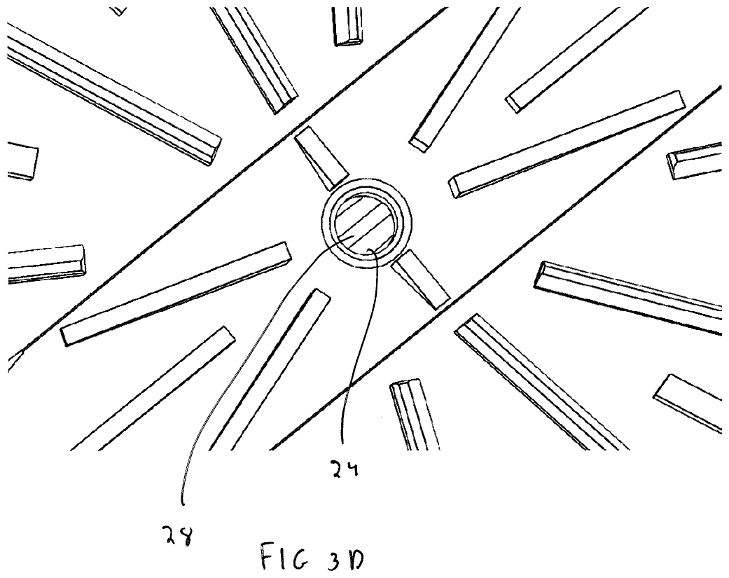

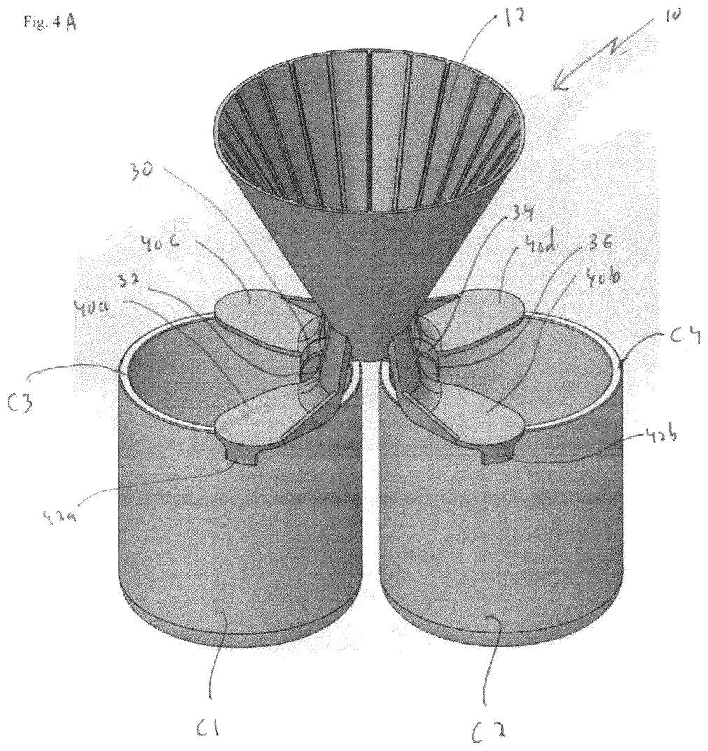

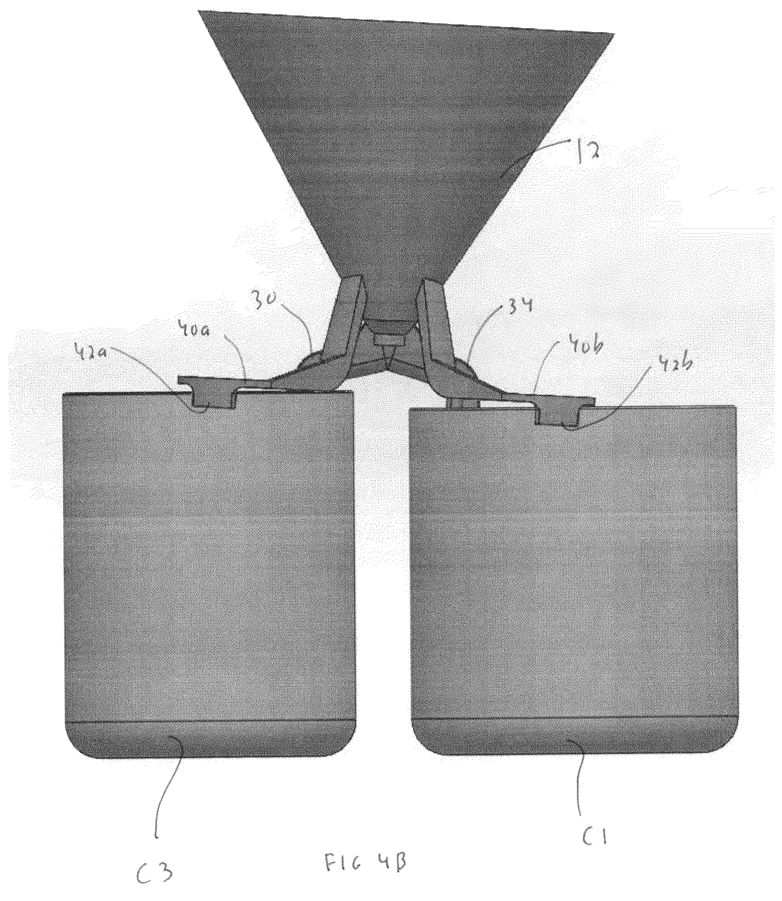

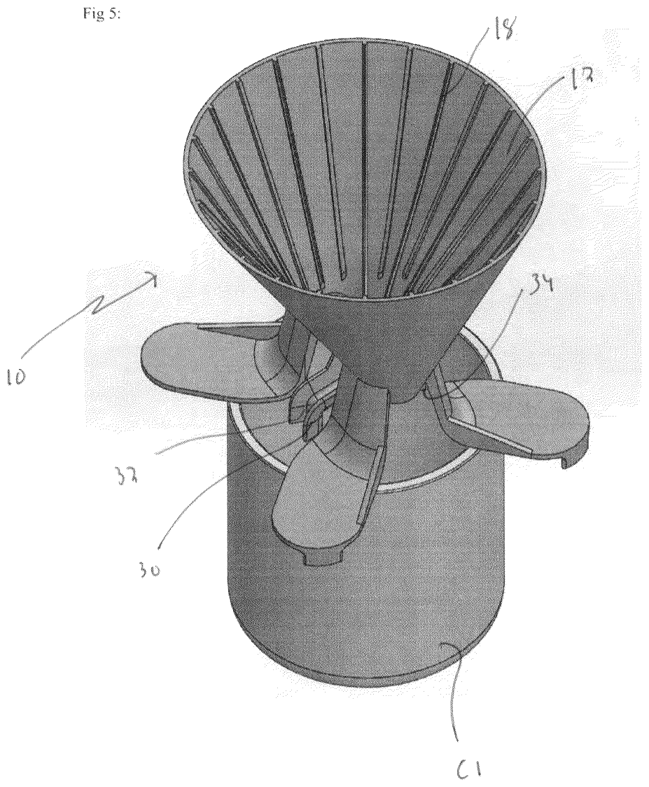

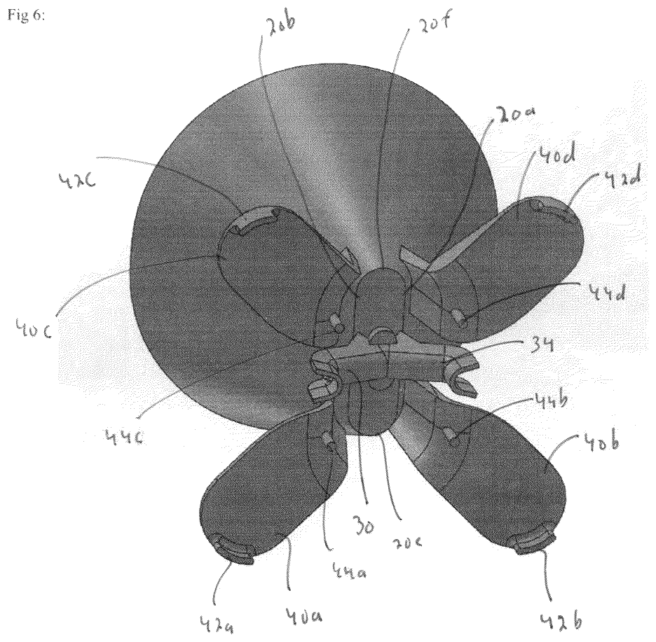

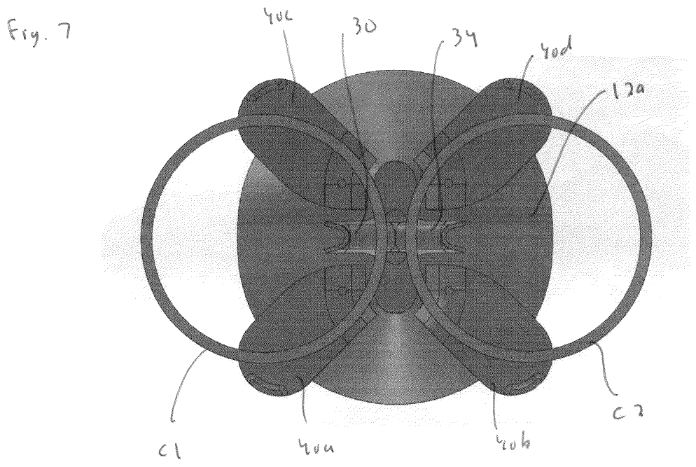

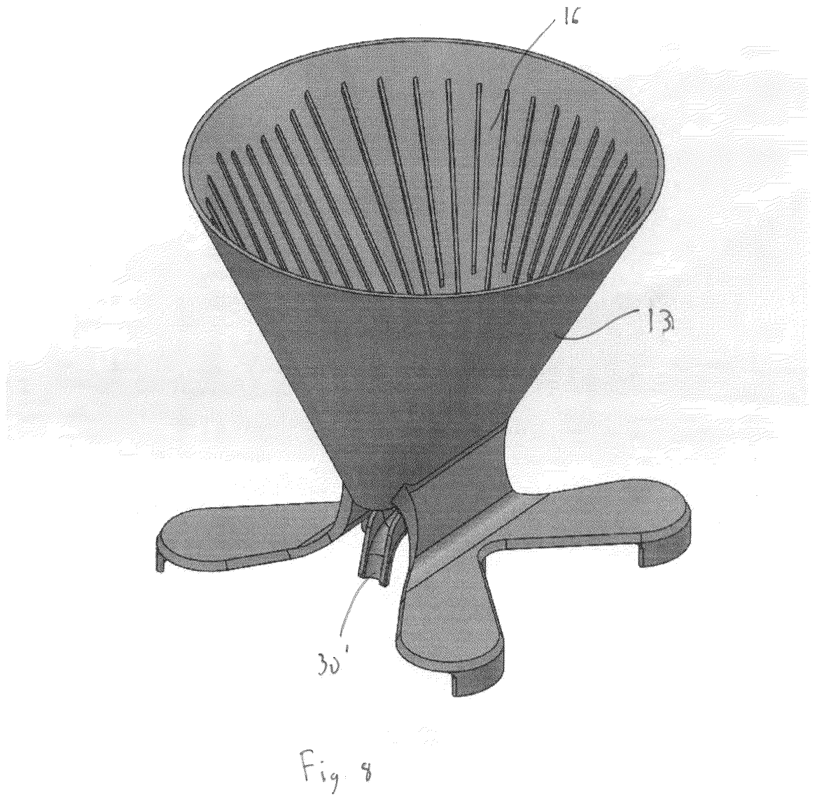

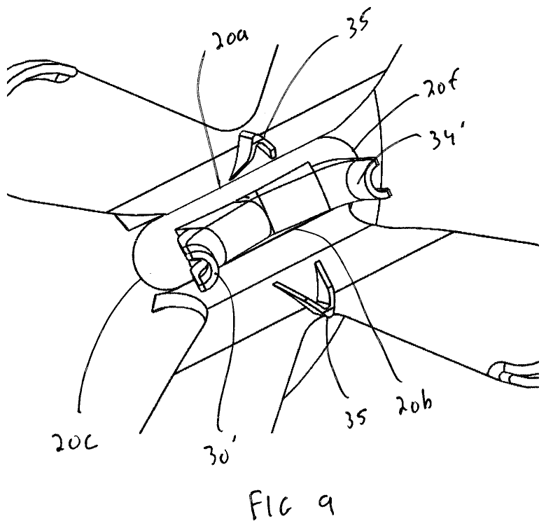

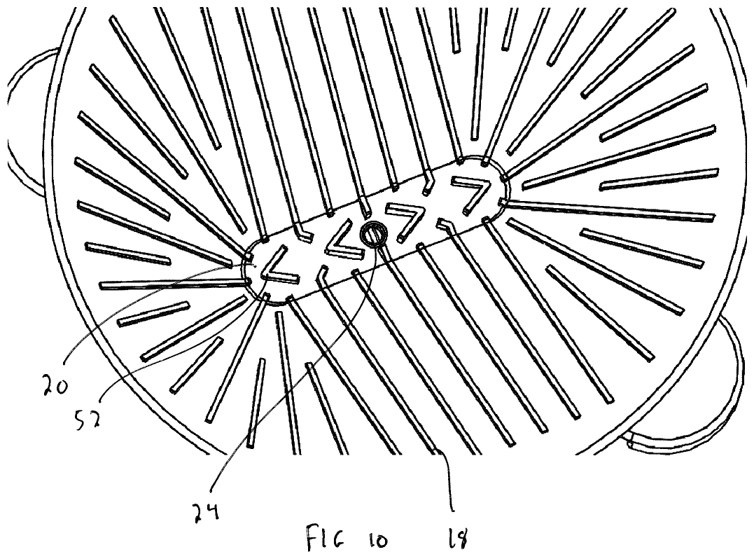

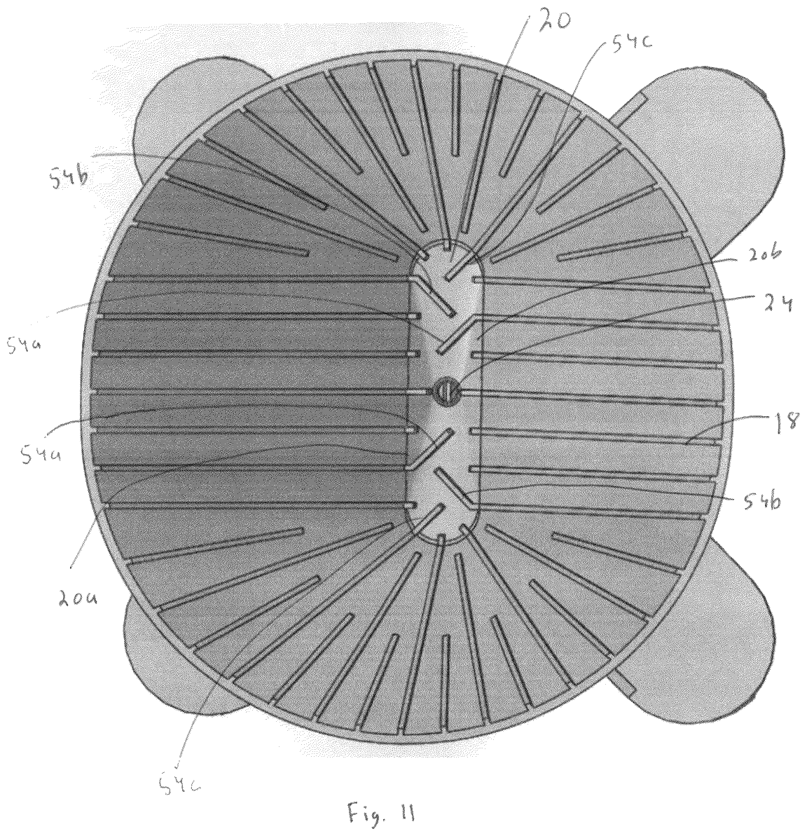

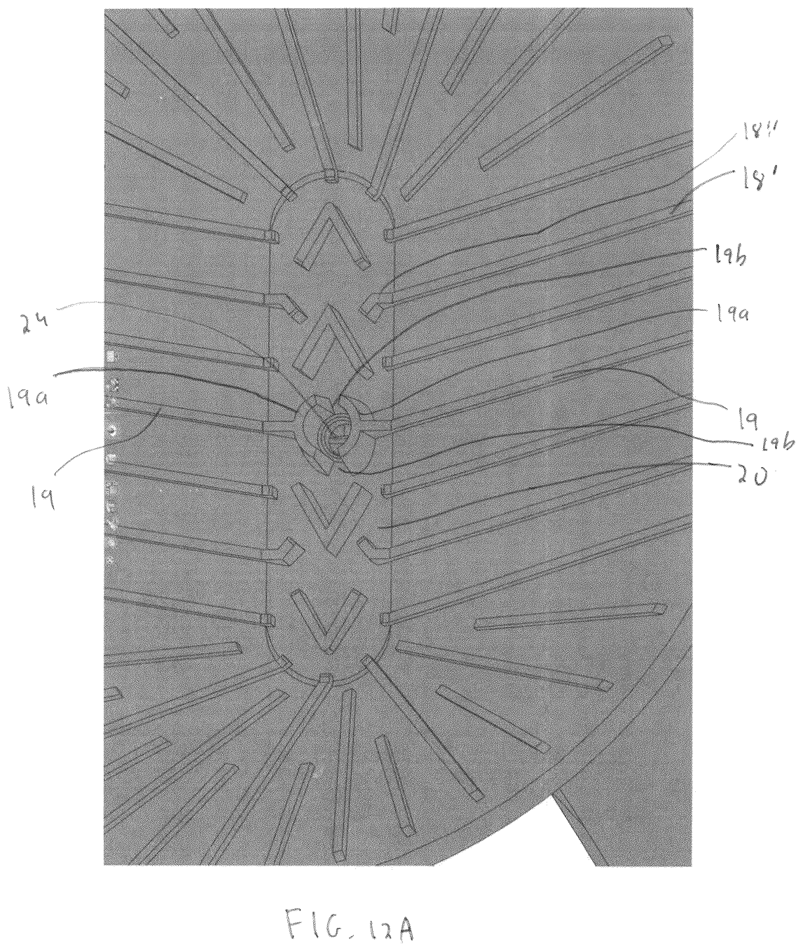

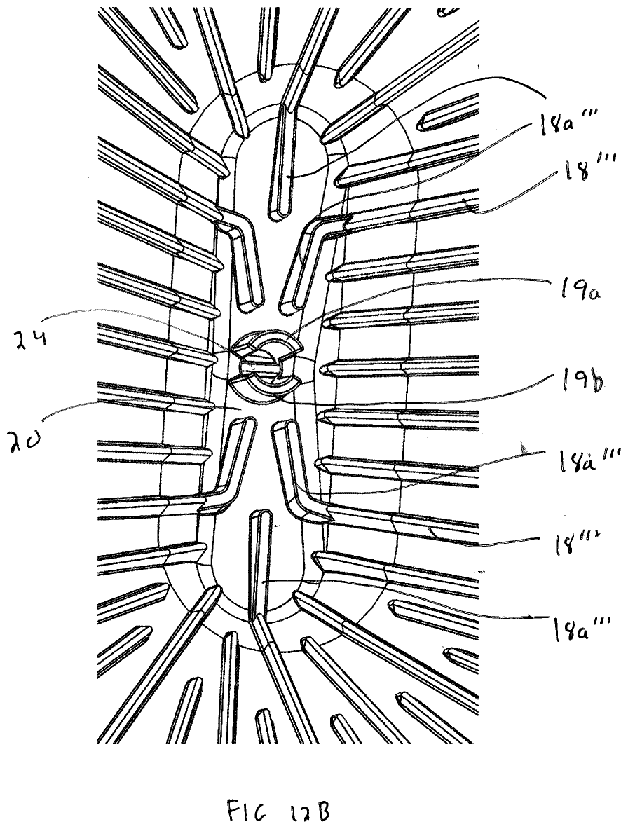

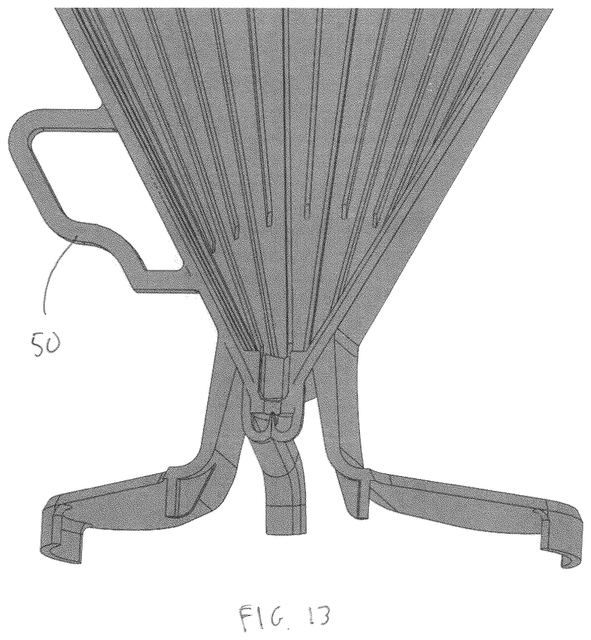

Various configurations and shapes of the floor ribs 22 are contemplated. In the embodiment of FIG. 3C, the ribs 22 are substantially triangular shaped when viewed from the side, with a top planar surface 22a and side surfaces 22b, 22c (only one of which is labeled in FIG. 3C for clarity). The ribs 22 increase in height h as they extend toward the drainage hole 24 as shown in FIG. 3C. The ribs 22 are also staggered in that on each side of the drainage hole 24, one of the floor ribs 22 has an end wall 22d which terminates further from the drainage hole 24 than the end wall 22d of the adjacent ribs 22 on each side (denoted by distance “D” in FIG. 3C). More specifically, in the floor rib configuration of FIG. 3C, on each side of the drain hole 24 are three floor ribs 22 (for a total of six ribs), two outer ribs extend at an angle toward the drainage hole 24 and a third non-angled rib extends between the two outer angled ribs, terminating before the terminal walls 22d of the two outer angled ribs. A different number of ribs 22 are contemplated as are different angles, different locations of the floor ribs and different configurations to space the filter from bottom surface 20 and help direct flow toward the drainage hole 24.

FIGS. 10 and 11 illustrate alternative floor rib configurations. The funnels of FIGS. 10 and 11 are the same as dripper 10 of FIG. 1, the only difference being the floor rib and side wall rib configuration and pattern. Therefore, the discussion herein of the features and use of the dripper 10 are fully applicable to the drippers of FIGS. 10 and 11 and therefore for brevity are not repeated herein. In FIG. 10, floor ribs 52 are V-shaped in configuration with two of the V-shaped ribs on each side of the drainage hole 24. The “opening” of the V faces the drainage hole 24 to enable flow around the rib (e.g., prevent pooling of filtrate between or around ribs for cleanliness/sanitary reasons). Thus, the ribs are designed so they do not prevent any flow from reaching the drain hole 24-they direct the flow but do not capture it.

Each of the ribs 52 can be the same configuration as shown or alternatively two of more of the ribs can be of different length, height, and/or thickness. The ribs 52 can also be of different configuration than the symmetrical “V” shape shown such as asymmetrical V configuration, symmetrical or asymmetrical U-shape, etc. The ribs 52 can also taper in height and/or width in a direction away from (or alternatively toward) the drainage hole 24. In the embodiment of FIG. 11, ribs 54 are linear and arranged in a staggered pattern with the innermost ribs 54a (closest to drainage hole 24) extending across a centerline of the bottom surface 20 toward an opposing wall 20a or 20b and the next pair of ribs 54 (intermediate ribs 54b) extending across the centerline toward the opposing wall 20b or 20a and the next pair of ribs 54c (furthest from the drainage hole 24) extending toward opposing wall 20a or 20b. Other arrangements of the ribs 54 are also contemplated. Also, other sizes, shapes, lengths, and/or thicknesses of ribs 54 are contemplated. One or more of the ribs 54 can taper in height and/or width in a direction away from (or alternatively toward) the drainage hole 24. The ribs may also be protrusions in the form such as columns/pillars or more organic topography arising from the bottom surface 20, such as peaks and valleys.

Additional ribs or flow guides may be desired in close proximity to the drain hole in the event that flow through the filter is slow (due to a restrictive filter or due to very fine coffee grounds). These ribs, such as depicted in FIG. 12A and 12B, will help direct the light flow or dribble into opposite sides of the divided drain hole to ensure more even split of flow into respective drain channels. That is, these ribs 19 force/direct flow of the liquid onto the splitter. As shown in FIG. 12A, ribs 19 terminate in C-shaped walls 19a, 19b partially encircling the drain hole 24. The drain hole 24 can be encircled in the amount shown or alternatively can extend less or more than that shown. The ribs 19 are separated to provide gaps 19b to direct flow. Note the ribs 19 as shown are arcuate forming C-shapes, but other shapes are also contemplated which in preferred embodiments would create gaps therebetween for directing flow onto the splitter as in ribs 19. Preferably a pair of ribs are provided spaced apart to provide two gaps, although a different number of ribs and/or gaps are also contemplated. In this embodiment, funnel ribs 18′ can extend into a portion of bottom floor 20 as shown with some having a slightly angled terminal end 18″ in an alternating pattern with ribs of non-angled or differently angled terminal ends. Ribs 19a, 19b of FIG. 12B are the same as ribs 19a, 19b of FIG. 12A, and function in a similar manner, except they are separate from funnel ribs 19 and not an extension thereof as in FIG. 12A. The ribs further differ from FIG. 12A in that the V-shaped ribs are not provided and instead the funnel ribs 18″′ have elongated linear portions (extensions) 18a″′ that extend onto the floor 20. As shown, there are three such rib extensions 18a″′ on each side of the drain hole 24, each extending in a direction toward the drain hole, forming a pattern so that on each side of the drain hole 43, two of the extensions are adjacent, with a third extension spaced behind relative to the drainage hole 24. Other patterns as well as lengths and angles of the rib extensions are also contemplated.

The floor ribs (e.g., 52 or 54), arranged/configured symmetrically or asymmetrically, also provide the advantage of preventing the filter seam (if left unfolded when placing filter) from obstructing flow around the drain hole. That is, if the filter seam is not folded over at the bottom edge when placed in the dripper funnel 12, the filter may be seated such that the seam slips between the ribs and blocks the drain hole 24. Thus, with the ribs of the present invention which extend past the centerline, even if the filter seam is not folded over when placed in the funnel 12, the ribs will deflect the seam and cause it to fold over and prevent potential partial or full blockage of the drainage hole 24. Alternatively, if the filter seam is not folded, the ribs can be designed to act as guides to position or restrain the filter seam in a desirable location (e.g., ribs with a center slot that act as receptacle for the filter seam) to minimize flow obstruction.

At the bottom of the drain hole 24, extending downwardly therefrom as shown in FIGS. 3A and 3B, is a flow divider 28 (also referred to herein as a splitter or separator) that leads to two (or more) drainage channels or pathways 30, 34 to split the stream of brewed coffee to allow filling of two separate but adjacent cups/mugs. FIG. 4A shows the dripper 10 seated over two adjacent cups with each drainage channel positioned to fill an individual cup. Seating of the dripper 10 on the cups is described in more detail below.

Flow divider 28, as best shown in FIG. 3C, has sloped side walls 28a and 28b extending downwardly and outwardly from top wall or edge (surface) 28c, defining the apex of the divider 28. The top wall/edge/surface 28c in the illustrated embodiment of FIG. 3C (and 3B) extends slightly into the drainage opening 24, i.e., slightly past the bottom of drainage opening 24. In alternate embodiments, the top wall 28c could be flush with the bottom of the drainage opening 24 or alternatively could terminate below the bottom of the drainage opening 24 or near the top or flush with the top of the drainage opening 24.

With reference to FIGS. 3A and 3B, the divider 28 splits the flow into two channels or guides 30 and 34 which extend in opposite directions, and are preferably spaced about 180 degrees apart, although other spacings are also contemplated. Channels 30 and 34 are in communication with drainage hole 24. Channel 30 extends from the bottom portion of the funnel 12 to distal end 32 and channel 34 extends from the bottom portion of the funnel 12 to distal end 36. The channels 30, 32 can be open ramps like configurations (see e.g., FIG. 1) or partially open, or alternatively can be enclosed channels except for the distal openings/spouts communicating with the underlying cup. The channels 30, 34 can be a U- or V-shaped concave cross-section, or they can be flow guides such as branches/arms or protrusions such as ribs, fins on a surface(s) that aim the flow in particular direction(s). Each drain channel 30, 34 is designed to fill a separate cup (also referred to herein as a vessel, liquid receiving vessel, receptacle or liquid receiving receptacle). Drain channels 30, 34 can take any path or direction, but for efficiency, the channels 30, 34 preferably run in opposite directions and are as short as possible to minimize temperature loss of the coffee but long enough to accommodate plurality of cup sizes/thicknesses. The channels 30, 34 angle outwardly downwardly along portion 30a, 34a as they emerge from the bottom of the funnel 12, and then extend more downwardly (i.e., more vertically) at the distal end portion 32a, 26a. Other angles are also contemplated as are other transitions to angles.

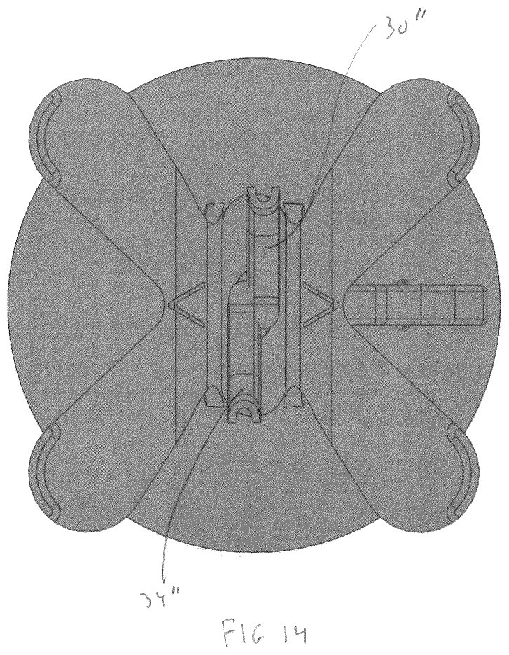

One example of alternate drain channel design is shown in FIG. 14 wherein the channels 30″ and 34″ originate on the sides of the drain hole then run in opposing directions, resulting in a more asymmetric channel/base design. This requires the flow divider to be oriented at 90 degrees with respect to the above-described designs (the divider now oriented in-line with the major axis of oval or ellipse), yet still allowing for the same functionality. That is, the divider (and its side walls 28a, 28b) in this embodiment would be positioned at an angle 90 degrees relative to direction of its channels from the position of divider 28 in FIG. 3C and its channels. The rib gaps would also be re-oriented (e.g., 90 degree rotation) accordingly.

The channels 30, 34 can be oriented in any direction relative to filter basket 12 or the oblong bottom 20. In the embodiment of FIG. 1, wherein the bottom surface is substantially oval or elliptical shaped and has elongated walls 20a, 20b (FIG. 6) on opposing sides (along a major axis) joined at each end by arcuate end walls 20c, 20f (along a minor axis), the channels 30, 32 are positioned transverse to the longer elongated walls 20a, 20b. That is, the channels 30, 32, are transverse to the major axis of the elliptical bottom. In the alternate embodiment of FIGS. 8 and 9, the channels 30′, 34′ extend in a direction along the longer elongated walls 20a, 20b so they are in line with the major axis of the elliptical bottom. Thus, the flow channels 30′ and 34′ in FIGS. 8 and 9 are offset 90 degrees from the flow channels 30, 34 of FIG. 1. The stoppers 35 on the dripper of FIG. 9 can be V-shaped or other than peg like (discussed below). Note the dripper of FIGS. 8 and 9 is otherwise the same as dripper 10 of FIG. 1 and include the various rib embodiments disclosed herein.

It should be understood that in alternate embodiments, a design with more than one drain hole, with each hole having at least one drainage channel, is also contemplated.

Note the bottom wall of the funnel is shown as elliptical, however other shapes including oblong shapes, circular shapes, non-circular shapes, symmetric shapes, asymmetric shapes, etc. are also contemplated.

Note the dripper 10 need not be used to fill two cups, but can, if desired, be positioned over a single cup with all drain channels supplying the same coffee cup, as depicted for example in FIG. 5. This is achievable via the short channel/spout design of the dripper 10.

It is also contemplated that the dripper 10 can be configured to fill more than two cups. In such alternate embodiments, the coffee dripper 10 described herein can have more than two drain channels below the dripper funnel to allow brewing into more than two cups. That is, in such embodiments, additional drainage channels would be provided, e.g., three drainage channels to fill three cups, each of the drainage channels configured to fluidly communicate with the drainage hole. The divider would be configured to split the flow accordingly, i.e., the divider would have a number of angled walls commensurate with the number of cups to be filled. For example, the divider/splitter would have three diverging angled walls forming a triangular shape for splitting flow into three cups, four diverging angled walls for splitting flow into four cups (e.g., a plus sign or cross shape,) etc. Thus, various funnels containing the selected divider can be utilized to accommodate the desired number of cups to fill simultaneously.

The drainage hole 24 is sized to achieve the optimal parameters of fluid flow. More specifically, it is sized such that it sufficiently restricts flow of the coffee filtrate to allow time for proper extraction and flavor of the brew. If the drain hole 24 is too large, the flow rate may become too high and does not allow for sufficient brewing of coffee grounds resulting in weak or poorly tasting coffee. If the drain hole 24 is too small, the pour-over process will brew/extract for too long, resulting in undesirable coffee taste and/or brew strength. However, a small drain hole allows the brewed coffee to pool/accumulate (flow backup) at the bottom of the filter cone just above the drain hole 24 therefore ensuring a continuous and more laminar flow through the hole. Thus, the drain hole of the present invention strikes this balance via an opening that is circular in shape and can have for example a diameter between about 2 mm and about 10 mm, and more preferably about 3 mm to about 5 mm, and in more preferred embodiments about 4 mm. Other diameters are also contemplated. Other drainage hole shapes, e.g., oblong, are also contemplated as long as they satisfy the foregoing parameters. It should also be appreciated that the size and thickness of the divider also impacts the effective area of the drain hole, e.g., a thicker divider reduces the effective area of the drain hole. Thus, the divider dimensions are selected to contribute to the optimal parameters of fluid flow.

The flow divider/splitter 28 at the bottom of the drain hole 24 splits the opening 24 into equal parts such that the volume of brew flowing through is evenly divided among the drain channels 30 and 34 (or 30′, 34′) originating from the divider 28 at the base of drain hole 24. This steady, more laminar flow ensures equal distribution of brew/filtrate among the drainage channels regardless of flow imbalance through the coffee filter. It further ensures equal distribution of brew/filtrate among the drainage channels even if the cups are of uneven height. That is, even if the dripper 10 is placed on cups of uneven height so the dripper 10 is tilted during brewing, the cups will still be filled evenly. If the flow is more turbulent or swirling at the drain hole 24, it may cause a flow imbalance and result in flow bias to one drain channel versus the other. (Placement of the arcuate ribs around the drain hole, discussed in detail below, also remedy this by forcing flow through the gaps). The dripper 10 of the present invention ensures that the plurality of cups being filled will have balanced volume of coffee despite uneven positioning of the dripper on the cups or uneven flow through the filter. FIG. 4B illustrates this concept wherein the dripper 10 is placed over cups C1 and C3 wherein cup C3 has a greater height than cup C1. As shown, this results in the cone 12 of dripper 10 and legs 40a, 40b being tilted, i.e., at an angle to the horizontal. However, this does not affect the balanced/even coffee flow as it is divided by the splitter 28 and divided into the two channels 30, 34 (or channels 30′, 34′). In this orientation, the flow balancing ability of present invention is maintained as each channel maintains a downward flow angle relative to the horizontal.

The illustrated embodiment depicts the drain hole 24 centered in the bottom surface/bottom wall 20 of the filter basket 12, however, in alternate embodiments, the drain hole 24 can be formed anywhere along the bottom of the filter basket 12 or along the side, as long as the hole facilitates drainage into the cups within the parameters described herein. In the illustrated embodiment, the drainage hole 24 is shown circular in configuration, however, the drainage hole(s) can alternatively be of other shape aperture or trough or depression that facilitates drainage of liquid away from the filter basket 12. Additionally, in alternate embodiments, more than one drainage hole can be provided, or the funnel/cone may have an elongated lower section that terminates as a drain hole(s) such that it is devoid of a distinct bottom surface 20.

Turning now to the base of the dripper 10, and with reference to FIGS. 1, 3A and 4A, the dripper 10 has a lower base having four legs or feet 40a, 40b, 40c, 40d (collectively feet or legs 40) on the bottom of the funnel cone 12. The legs 40a-40d extend downwardly from the funnel cone exterior surface 13 and flare out in an “X” pattern, where each leg or foot 40a, 40b, 40c, 40d is directed outward at approximately 45 degrees away from center, so as to maximize contact with the outermost rim sections C3, C4 of the cups C1, C2, respectively, in both the X and Y axis relative to the center of dripper 10 as viewed from the top. Note that outwardly extending degrees greater or less than 45 degrees are also contemplated. To provide stability over a wide range of cup sizes, the legs 40a-40d are designed of sufficient width W and length L to ensure adequate contact area and stability when seated on small, medium, or large diameter cups. The optimal base design is one that maximizes cup rim contact whether it is placed over/seated on only one cup (as in FIG. 5) or placed over/seated on two cups (as in FIG. 4A). Lateral stability of the dripper is maximized when the feet 40a-40d are supported by (in contact with) the outermost edges of the cup rim(s) as measured from the center of gravity of the funnel 10 which coincides with the location of the drain hole 24 in a top-down view. As shown in the example of FIG. 4A, legs 40a and 40c are placed over cup C1 and legs 40b and 40d are placed over cup C2, with the spout 32 between legs 40a and 40c directed into cup C1 and spout 36 between legs 40b and 40d directed into cup C2. The bottom surface of legs 40a and 40c as illustrated rest atop/abut rim C3 of cup C1 on opposing sides of the rim C3 and a bottom surface of legs 40b and 40d rest atop/abut rim C4 of cup C2 on opposing sides of rim C4.

The X base configuration of the legs 40a-40d is well suited to provide optimal stability when placed on one cup or two, while also allowing visibility of the interior of the cups and the dripper spout ends 32, 36 via gaps or spaces between the base legs/feet 40a-40d. It is beneficial for the user to see these areas during brewing to ensure the cups don't overflow and to know when flow of brew has stopped or has been interrupted. Other base shapes and configurations, such as circular, oval, oblong, etc. are also contemplated, however, the X configuration has good balance of stability over a wide range of cup sizes, flow/spout visibility, and manufacturability. This visibility in the gap between the legs to expose the spout ends 32 and 36 can be appreciated in the illustration of FIGS. 4A and 5.

The underside of the dripper base as shown in FIG. 6 has features or stoppers that prevent the dripper 12 from displacing or sliding sideways and tipping over, allowing it to securely sit on the rim of a wide range of cup/vessel sizes. That is, the features or stoppers prevent the dripper from sliding off the cups, i.e., from moving too far to the side since the stoppers will contact the inside or outside wall of the cup.

More specifically, each leg 40a, 40b, 40c, 40d on its underside has a respective outer stopper 42a, 42b, 42c, 42d and a respective inner stopper 44a, 44b, 44c and 44d closer to the dripper center than the outer stoppers 42a-42d. The inner stoppers 44a-44d in the illustrated embodiment are cylindrical or peg shaped extending downwardly and perpendicular to the bottom/lower surface of the respective leg from which it extends and is located nearer the center of the funnel 12. The outer stoppers 42a-42d in the illustrated embodiment are arcuately shaped (open C-shape) as they follow the curve of the outer edge of the respective leg and extend downwardly from an outer edge of the respective leg. The inner stoppers 44a-44d and outer stoppers 42a-42d can be of the same height, or alternatively two or more of the stoppers 44a-44d and/or 42a-42d can be of different heights, defined as the distance from the bottom surface of the leg to the bottom most end. It should be appreciated that other shapes of the inner stoppers and/or outer stoppers are also contemplated. It should also be appreciated that the inner stoppers and/or outer stoppers can be positioned at locations other than that shown in FIG. 6. Alternative shaped inner stoppers such as stoppers 35′ as shown in FIG. 9 are V-shaped and positioned at a central portion of leg pairs (the legs in this embodiment are joined with a pair on each side of the long wall of the bottom surface).

During use, each drainage channel downspout 30, 34 can also serve as a stopper that engages the inside rims/walls of the cups they are being positioned over to limit lateral movement of the dripper and ensure drainage inside the cup. Stoppers to limit movement can also be provided adjacent the spouts such as in the embodiment of FIG. 9.

The downspouts 32, 36 are spaced to accommodate at least two cup rims or edges, yet close enough that they both can fit within a single cup if the dripper 10 is used to fill a single cup. The spouts 32, 36 and stoppers 42a-42d, 44a-44d may also act as guides or aids for correct placement by hitting the cup rim and providing feedback to the user when placing the dripper 10 onto the cup(s). Proper seating and stability are beneficial since the dripper of the present invention is intended to brew multiple beverage servings and can be top-heavy when the filter basket is full of water during the pour-over brewing process.

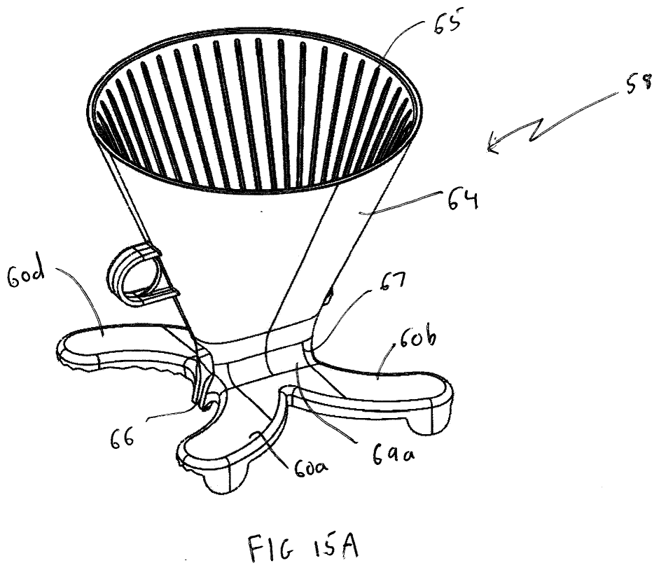

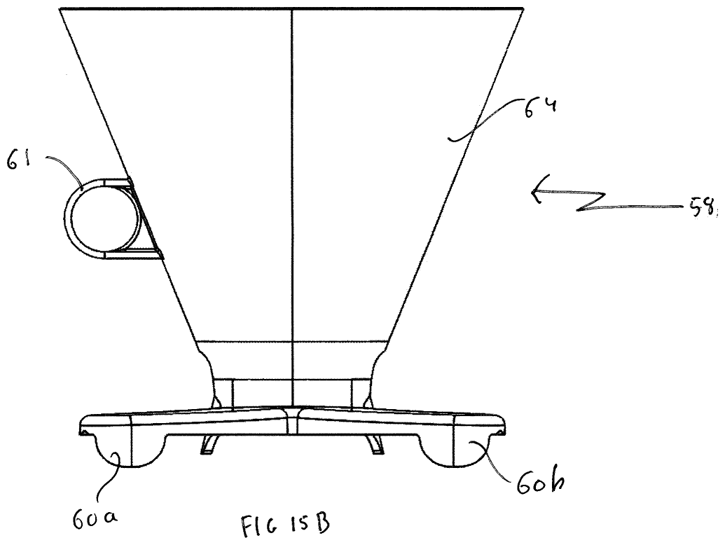

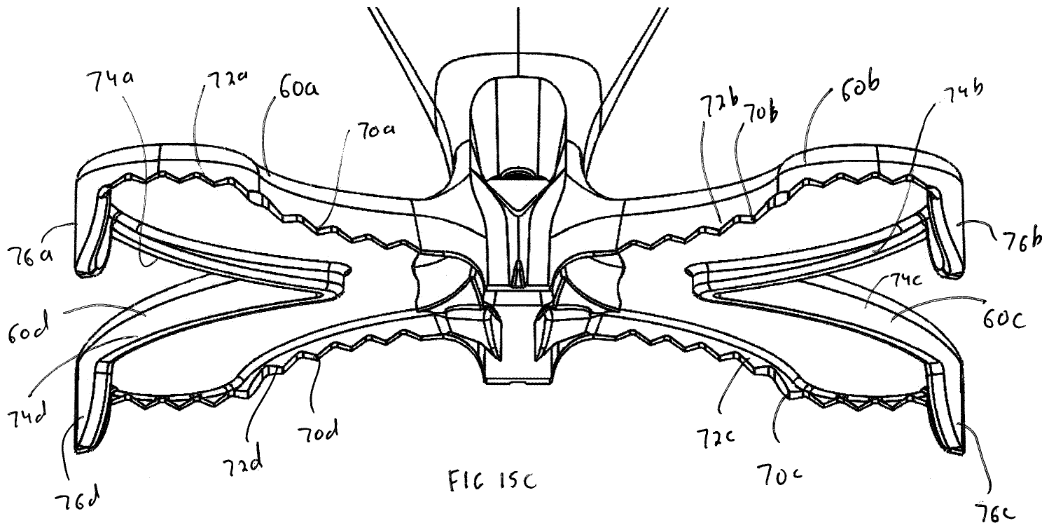

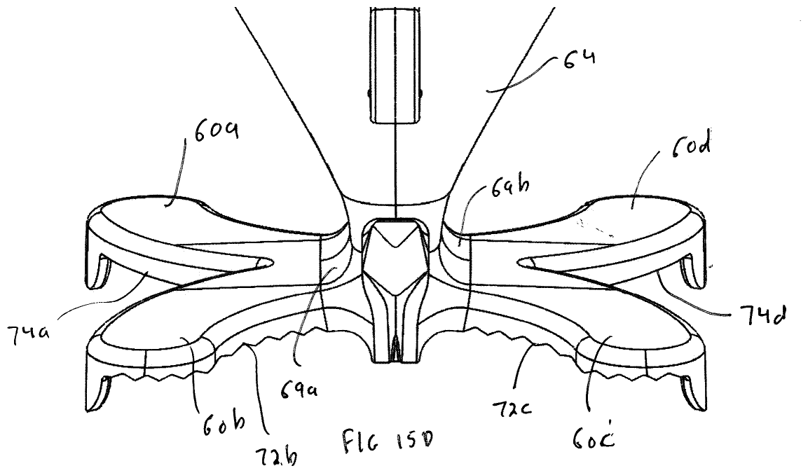

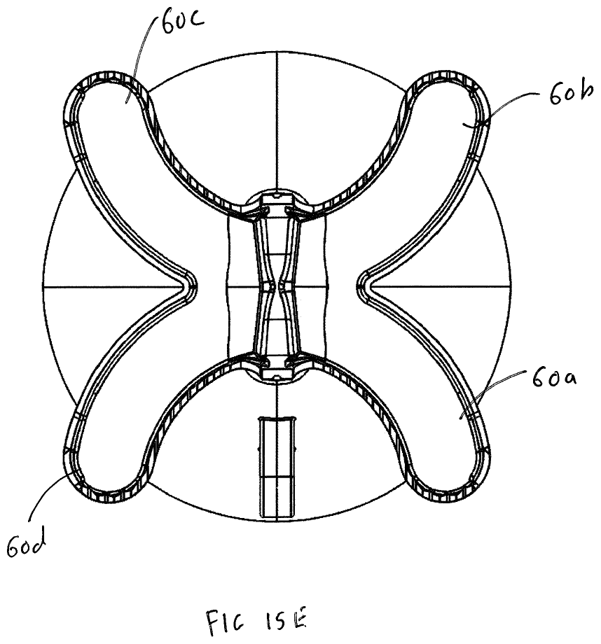

FIGS. 15A-17 illustrate an alternate embodiment of the dripper of the present invention. Dripper 58 is similar to the dripper of FIGS. 8 and 9 except for the configuration and features of the legs 60 and provision of handle 61. That is, the funnel 64, spouts 66, 68, funnel ribs 65, floor ribs, drain hole can be the same as in dripper 30′ of FIG. 8 or the same as the other drippers disclosed therein. Therefore, for brevity, these features and their function will not be repeated herein since the discussion of these features and the function as described herein are fully applicable to dripper 58. Further, it should be appreciated that the leg configuration, features and function of legs 60 can be utilized with the other dripper embodiments disclosed herein. The discussion of the embodiment of FIGS. 15A-17 will focus on the differing leg configuration.

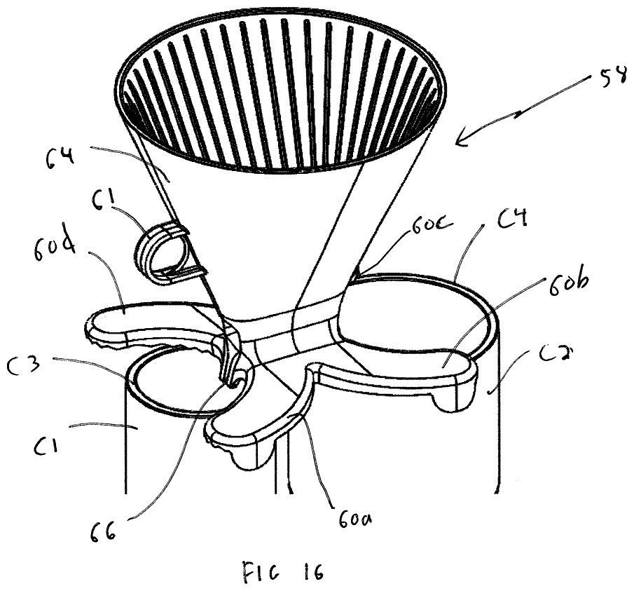

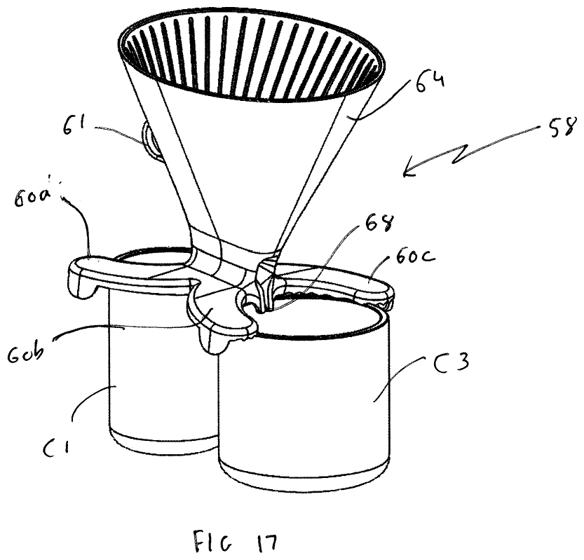

Legs (or feet) 60 comprise four legs 60a, 60b 60c, 60d (collectively feet or legs 60) on the bottom of the funnel cone 64. The legs 60a-60d extend downwardly at their proximal edges from the funnel cone exterior surface 67 and then flare out in a curved “X” pattern, where each leg or foot 60a, 60b, 60c, 60d curves outwardly from the center, and has an arcuate wall as shown. The legs 60 are designed to maximize contact with the outermost rim sections C3, C4 of the cups C1, C2, respectively, in both the X and Y axis relative to the center of dripper 10 as viewed from the top. To provide stability over a wide range of cup sizes, the legs 60 are designed of sufficient width W and length L to ensure adequate contact area and stability when seated on small, medium, or large diameter cups. As shown in the example of FIG. 16, legs 60a and 60d are placed over cup C1 and legs 60b and 60c are placed over cup C2, with the spout 66 between legs 60a and 60c directed into cup C1 and the opposing spout 68 between legs 60b and 60c directed into cup C2. The bottom surface of legs 60a and 60d as illustrated rest atop/abut rim C3 of cup C1 on opposing sides of the rim C3 and a bottom surface of legs 60b and 60c rest atop/abut rim C4 of cup C2 on opposing sides of rim C4. FIG. 17 shows engagement of the dripper 58 with cups C1, C3 of different size/height. Dripper 58 has handle 61 to facilitate handling.

The X base configuration of the legs 60 provide optimal stability when placed on one cup or two, while also allowing visibility of the interior of the cups and the dripper spout ends 66, 68 via gaps or spaces between the base legs/feet 60a-60d.

Note the legs 60 can be considered as connected in two pairs with a first pair, legs 60a, 60b, spreading outwardly from wall 69a and a second pair, legs 60c, 60d, spreading outwardly from wall 69b (see FIGS. 15D).

The underside of the legs 60 have a series of ridges forming a sawtooth like configuration. The ridges 70a, 70b, 70c, 70d (collectively ridges 70) can extend a full or partial length of one or more of walls 72a, 72b, 72c and 72d. This sawtooth 70 functions as a stopper to engage the rim of the cup and limit sliding movement of the dripper 58. The ridges extend along the length of each leg to accommodate cups of different rim diameters. In the illustrated embodiment, ridges 70 extend along the outer wall of the leg. More specifically, ridges 70a extend along the bottom surface of outer wall 72a of leg 60a but not along inner wall 74a; ridges 70b extend along the bottom surface of outer wall 72b of leg 60b but not along inner wall 74b; ridges 70c extend along the bottom surface of outer wall 72c of leg 60c but not along inner wall 74c; ridges 70d extend along the bottom surface of outer wall 72d of leg 60d but not along inner wall 74d. That is the ridges 70 extend downwardly from an outer wall of each of the legs 60. However, it should be understood that ridges can also be provided along a full or partial length of one or more of inner walls 74a, 74b, 74c and 74d. These sawtooth features prevent the dripper 58 from displacing or sliding sideways and tipping over, allowing it to securely sit on the rim of a wide range of cup/vessel sizes. That is, the sawtooth features form stoppers prevent the dripper from sliding off the cups, i.e., from moving too far to the side since the stoppers will contact the inside or outside wall of the cup. The ridges in preferred embodiments are spaced about 5 mm apart (peak to peak) designed to fit/grip a variety of cup rim thicknesses, sizes. The sawtooth features can also be another shape such as repeating arches, gaps, or other protrusions that facilitate cradling or nesting of the cup rim between them.

Each leg 60a, 60b, 60c, 60d on its underside has a downwardly extending extension 76a, 76b, 76c, 76d (FIG. 15c), respectively, which can act as an outer stopper to engage a rim of the cup.

Ideally the two cups/mugs being filled are the same (of the same height), but as discussed above, the dripper 10 of the present invention can accommodate some difference in cup rim height or size and allows for substantially uniform filling of two or more cups of different height. The features and feet on the underside or base of the dripper allow placement on one cup or multiple cups of various sizes without adversely affecting stability and functionality of the dripper. The different sizes of the cups can be due to the cups being from different sets or from the same set but slightly different due to manufacturing tolerances.

The funnel or filter basket 12 of the dripper of the present invention can be sized to hold a filter or volume of coffee for at least one brewed cup but preferably two or more cups, for example such as size #4 Melitta-style conical filters. In embodiments for filling more than three cups simultaneously, the filter basket may be sized to hold a higher volume.

As discussed above, the elongated ribs on the inner surface/inner wall of the funnel create capillary spaces between the filter and inner funnel walls to enable liquid (filtrate) drainage or flow through the filter. This ensures uniform flow between the funnel wall and filter towards the drain hole from all sides. These ribs/ridges/features also prevent pooling/accumulation of liquid on one side of the filter and ensure uniform and more consistent extraction of coffee within the filter.

However, it may be desirable to limit flow through some parts of the filter such as the top, so that hot water has time to mix with coffee grounds and extract the flavors before passing through the filter wall. In this case, in alternate embodiments, the funnel wall may have the ribs 18 gradually protrude from the inner wall surface about halfway down the funnel 12) (i.e., at the lower half of the funnel) to ensure flow through the filter wall only occurs in the bottom half of the filter.

It should be appreciated that although described above for coffee, the dripper of the present invention can be used for brewing other drinkable liquids/beverages, such as tea, matcha, etc.

The dripper described herein may also incorporate a handle or grip(s) 50 for easier handling external to the filter basket 12, such as depicted in FIG. 13, wherein the user can handle the dripper safely with hot contents. In all other respects the dripper of FIG. 13 can be the same as the various dripper embodiments described herein. Any of the drippers disclosed herein can include a handle.

The dripper of the present invention can be made of glass, ceramic, porcelain, metal, plastic or polymer, silicone, wood/bamboo or any heat resistant material organic or inorganic, or a combination thereof. Preferably, the dripper of the present invention is made of a commonly used kitchenware or dishware material such as plastic, glass or ceramic or stainless steel, so it is durable, non-chemical leeching, and does not degrade or wear out over time e.g., does not degrade due to repeated dishwasher cycles. Also, the material should not adversely affect flavor of the brew/coffee.

The dripper of the present invention is not limited to conical type coffee filters and the invention can be applied to basket or flat-bottom type filters such as basket-style coffee filters. Other filter types and materials are also contemplated such as metal or cloth filters.

The dripper of the present invention can be made of a single piece of material (i.e., single piece of molded plastic or ceramic), or alternatively can be made of two or more pieces of similar or of dissimilar materials if deemed advantageous (i.e., such as for cleaning or travel purposes or for adapting to other filter types).

In an alternate embodiment, instead of the X-shaped leg configuration, the base of the dripper can be made circular/oblong, or other shape, of sufficient size so it can sit on two cups. In such embodiment, instead of the radially extending legs, the bottom of the base, or a downwardly extending support, would sit directly on the cup rims and the spouts at the base would overlie the cup openings. For example, the dripper can taper inwardly distally at the funnel as in the illustrated embodiments, but the base would sufficiently widen to sit on multiple cups. The base and/or support could include stoppers to limit sliding of the dripper.

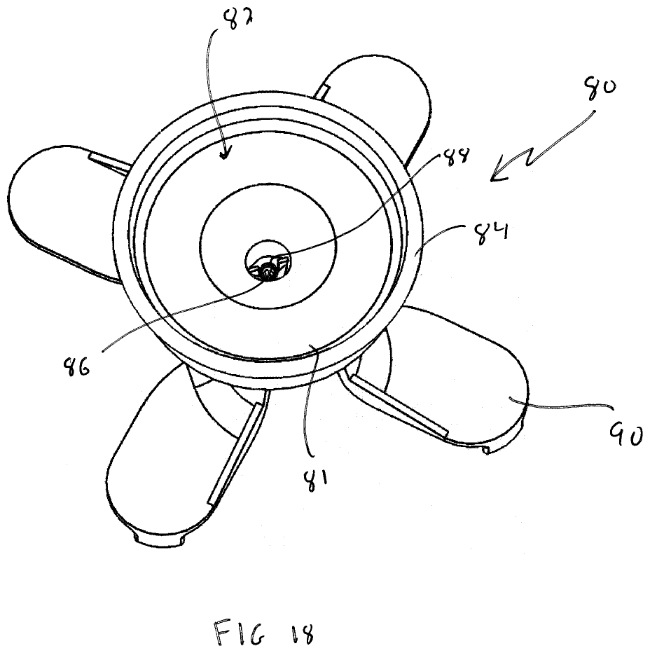

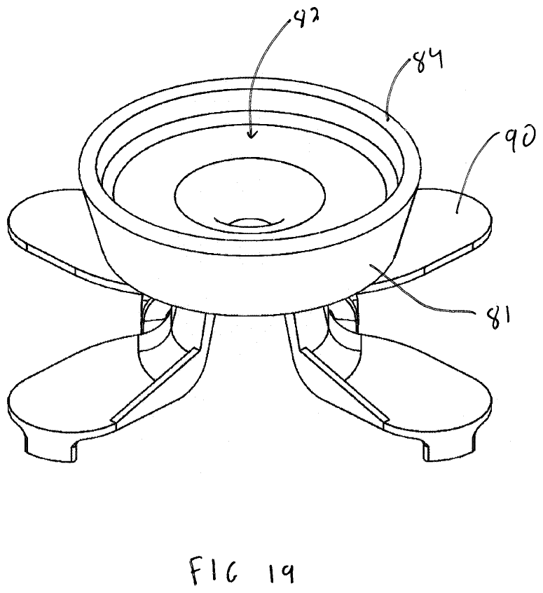

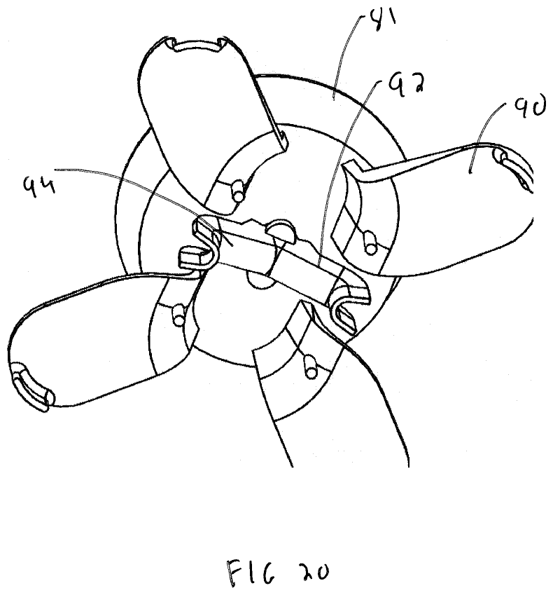

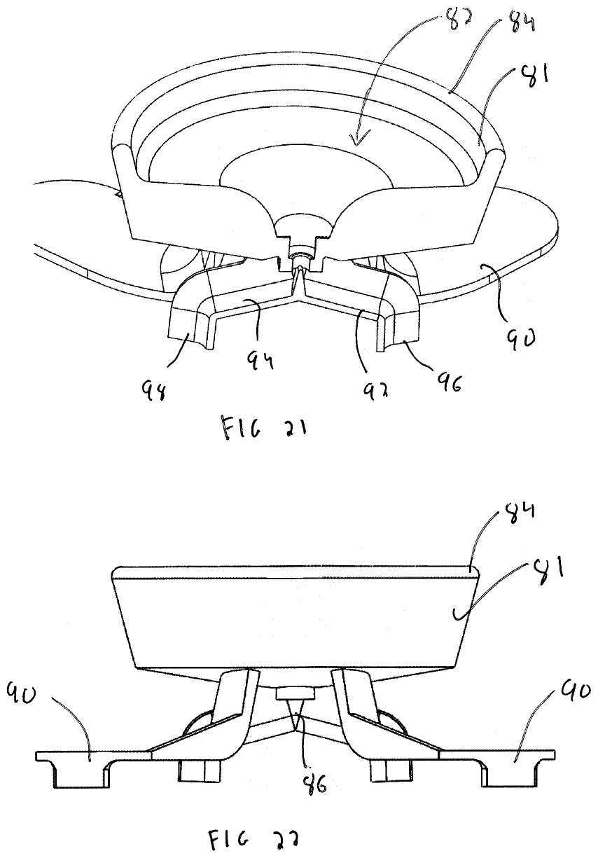

In another embodiment, the flow splitting features of the present invention can be an attachment or an insert (e.g., an accessory) for existing drippers to permit brewing into multiple cups simultaneously. This is depicted for example in the embodiment of FIGS. 18-22. For example, a base or stand comprising a shallow reservoir with the drain hole, flow splitter below the drain hole and drain channels/spouts can be adapted for use with other single-cup drippers to enable filling of two or more cups at the same time. For example, an existing single cup dripper can be placed on top of such liquid splitting accessory to allow filling of two cups. As the liquid exits the single cup dripper, it will be divided by the underlying splitter/divider and directed through two spouts into two separate cups. The accessory can also include more than two spouts so the accessory can divide the liquid from an existing single cup dripper into more than two cups. In such uses of transforming a single cup dripper into multiple cups, the base or stand could also include the mounting feet or legs described above (as well as the stoppers) for securing/stabilizing the base or stand to the underlying cups.

With particular reference to FIGS. 18-20, the dripper of the present is provided as an adapter or accessory, designated generally by reference numeral 80. The dripper (also referred to herein as the dripper adapter 80) has the radial feet 90 (legs), the channels 92, 94 and spouts 96, 98, the drain hole 88, floor ribs and splitter 86 as described in the various embodiments above and therefore for brevity are not further described herein as they function in the same manner as the other embodiments disclosed herein. The adapter 80 differs from the aforedescribed drippers since instead of the funnel, it utilizes the funnel of existing/third party drippers. More specifically, base 81 includes a receptacle 82 having a circular rim 84 configured and dimensioned to receive the base of existing/current commercial drippers. In this manner, the base of an existing/current dripper is seated atop and in abutment with the rim 84 of the adapter of the present invention instead of seated on a cup rim. The liquid poured into the third party dripper will then flow into receptacle 82 and through the drain hole 88 of the adapter 80 and onto splitter 86, in the same manner as described above to split/divide the liquid into two cups. Stated another way, the adapter 80 is interposed between the existing dripper and the two cups into which the liquid is separated and flows. Thus, as can be appreciated, the dripper adapter 80 of the present invention functions as an accessory to existing drippers to split the flow.

Note in alternate embodiments, instead of seated on rim 84, the receptacle 81 can be configured so that the existing dripper is partially placed/inserted within the receptacle, e.g., the base is within the receptacle, and can, in some embodiments, be supported on a shelf or lip formed in the receptacle 81 and extending from an inner wall thereof.

While the above description contains many specifics, those specifics should not be construed as limitations on the scope of the disclosure, but merely as exemplifications of preferred embodiments thereof. Those skilled in the art will envision many other possible variations that are within the scope and spirit of the disclosure.

Although the apparatus and methods of the subject invention have been described with respect to preferred embodiments, which constitute non-limiting examples, those skilled in the art will readily appreciate that changes and modifications may be made thereto without departing from the spirit and scope of the present invention.

Additionally, persons skilled in the art will understand that the elements and features shown or described in connection with one embodiment may be combined with those of another embodiment without departing from the scope of the present invention and will appreciate further features and advantages of the presently disclosed subject matter based on the description provided.

Throughout the above description, terms such as “approximately,” “about”, “generally,” “substantially,” and the like should be understood to allow for variations in any numerical range or concept with which they are associated. It is intended that the use of terms such as “approximately”, “about”, “substantially”, and “generally” should be understood to encompass variations on the order of 25%, or to allow for manufacturing tolerances and/or deviations in design.

Where a range of values is provided, it is understood that each intervening value, between the upper and lower limit of that range is encompassed within the invention.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present invention.

The phrases “at least one of A, B, and C” and “A and/or B and/or C” should each be interpreted to include only A, only B, only C, or any combination of A, B, and C.

1. An apparatus for splitting drinkable liquid flow comprising:
a) a funnel having a proximal portion and a distal portion, the funnel configured to receive a liquid therein;
b) a first wall having a drain hole, the funnel opening to the wall to provide flow onto the first wall; and
c) a splitter positioned adjacent the drain opening, the splitter configured to separate the liquid into i) a first liquid portion for flow into a first liquid receptacle and ii) a second liquid portion for flow into a second liquid receptacle.

2. The apparatus of claim 1, wherein the funnel is configured to receive an insert for brewing or steeping a liquid.

3. The apparatus of claim 1, further comprising first and second ribs extending from the first wall adjacent the drain hole, the first and second ribs spaced apart to create first and second gaps to direct liquid flow through the drainage hole and onto the splitter.

4. The apparatus of claim 3, wherein the first and second ribs are arcuate in configuration and partially surround the drain hole.

5. The apparatus of claim 1, wherein the splitter comprises first and second walls extending at an angle with respect to the drain hole.

6. The apparatus of claim 1, wherein the splitter is centered with respect to the drain hole.

7. The apparatus of claim 1, further comprising a plurality of ribs extending inwardly from an inner wall of the funnel.

8. The apparatus of claim 7, wherein the plurality of ribs extend onto the first wall and terminate at a distal region extending upwardly from the first wall.

9. The apparatus of claim 8, wherein the distal region of the plurality of ribs extend at an acute angle to a longitudinal axis of the first wall.

10. The apparatus of claim 1, wherein the first wall is sloped downwardly toward the drain hole.

11. The apparatus of claim 1, further comprising a plurality of legs extending radially with respect to the first wall, the plurality of legs configured to engage the first and second liquid receptacles.

12. The apparatus of claim 11, wherein the plurality of legs include a plurality of ridges on a bottom surface to engage a rim of the first liquid receptacle to prevent sliding on a rim of the first liquid receptacle.

13. The apparatus of claim 11, further comprising first spout to communicate with the first liquid receptacle and a second spout to communicate with the second liquid receptacle, wherein the plurality of legs have projections on a bottom surface for spacing the apparatus from a surface on which the apparatus is placed so the first and second spouts are out of contact with the surface.

14. The apparatus of claim 1, wherein the splitter is configured to divide the liquid into the first liquid receptacle and the second liquid receptacle of either a same size or a different size.

15. The apparatus of claim 1, wherein the plurality of legs form a substantially x-shape to match a shape of the first receptacle over which it is mounted.

16. The apparatus of claim 1, further comprising first and second channels extending radially outwardly with respect to the first wall, each of the first and second channels having an exit for the liquid from the apparatus to one of the first and second liquid receptacles, the exit of the first and second channels being downstream of the splitter.

17. An apparatus for splitting drinkable liquid flow comprising:
a) an elongated wall having a drain opening formed therein;
b) a splitter positioned adjacent the drain opening, the splitter configured to separate the liquid into i) a first liquid portion for flow into a first liquid receptacle and ii) a second liquid portion for flow into a second liquid receptacle; and
c) a plurality of legs extending radially with respect to the elongated wall configured to engage the first and second liquid receptacles.

18. The apparatus of claim 17, further comprising a receptacle to receive liquid from a dripper.

19. The apparatus of claim 18, wherein the receptacle has a rim, and a base of the dripper is seated on the rim such that the liquid flows from the dripper onto the splitter.

20. The apparatus of claim 18, wherein the receptacle has an opening, and a portion of the dripper is positioned within the receptacle, wherein the liquid flows from the dripper onto the splitter.
